(19) United States
(12) Patent Application Publication
(10) Pub. No.: US 2007/0165852 A1
(43) Pub. Date: Jul. 19, 2007

(54) Watermark detection

(75) Inventor: David K. Roberts, CRAWLEY (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,821

(22) PCT Filed: Feb. 8, 2005
(86) PCT No.: PCT/IB05/50497

§ 371 Date: Aug. 9, 2006

(30) Foreign Application Priority Data
Feb. 14, 2004 (GB) 0403331.2

(51) Int. Cl. H04N 7/167

(52) U.S. Cl. 380/201

(57) ABSTRACT

A detector (100) detects the presence of a watermark in an information signal. The information signal is correlated with an expected watermark (Wi) for each of a plurality of relative positions of the information signal with respect to the watermark to derive a set of correlation results (64). A metric, such as a mean square value, is calculated for a cluster of the results (64). The metric is compared with a threshold h which is indicative of the cluster representing the presence of a correlation peak. The metric can be calculated for clusters formed at every position in the results buffer (64). Alternatively, the metric can be calculated only for a cluster which is identified as being a likely correlation peak.

Watermarking is a technique in which a label of some kind is added to an information signal. The information signal to which the watermark is added can represent a data file, a still image, video, audio or any other kind of media content. The label is embedded in the information signal before the information signal is distributed. The label is usually added in a manner which is imperceptible under normal conditions, in order that it does not degrade the information signal, e.g. a watermark added to an audio file should not be audible under normal listening conditions. However, the watermark should be robust enough to remain detectable even after the information signal has undergone the normal processes during transmission, such as coding or compression, modulation and so on.

Many watermarking schemes employ correlation as a detection technique, with a signal under test being correlated with a signal containing a known watermark. In these systems, the presence of a watermark is indicated by one or more peaks in the correlation results. The paper “A Video Watermarking System for Broadcast Monitoring”, Ton Kalker et al., Proceedings of the SPIE, Bellingham, Va. vol. 3657, 25 Jan. 1999, p. 103-112, describes a scheme for detecting the presence of a watermark in broadcast video content. In this paper, the height of the resulting correlation peaks are compared to a threshold to decide whether the audio/video content is watermarked or not. The threshold value is chosen such that the false positive probability (the probability of declaring a watermark present, when in fact the audio/video is not watermarked) is suitably low. A typical threshold value is 5 σ (five times the standard deviation of the correlation results).

In most applications the watermarked content will undergo various processing operations between the point at which a watermark is embedded in the content and the point at which the presence of the watermark is detected. A common example of content processing is lossy compression, such as MPEG coding. Typically, the effects of processing are to lower the correlation peaks that would normally be expected to occur during the watermark detection process. Thus, the performance of a watermark detection technique based on finding correlation peaks is considerably reduced when attempting to detect watermarks in content which has undergone such processes.

The present invention seeks to provide an improved way of detecting a watermark in an information signal.

Accordingly, a first aspect of the present invention provides a method of detecting a watermark in an information signal, comprising:

deriving a set of correlation results by correlating the information signal with a watermark for each of a plurality of relative positions of the information signal with respect to the watermark;

calculating a metric which is based on a cluster of the results selected from the overall set of results; and

comparing the calculated metric with a cluster threshold value which is indicative of the cluster representing a correlation peak.

It has been found that the processing which many information signals experience during distribution can have the effect of smearing a correlation peak when it is attempted to detect the watermark using a correlation technique. By using a metric which is based on a cluster of correlation results, rather than an isolated result, it is possible to identify watermarked content even where processing or other attacks have degraded the quality of the watermark, reducing the height of the correlation peak below the threshold normally used for detection. This improves performance of the watermark detector and extraction of the watermark payload.

The ability to detect watermarks that are only weakly present in an item of media content also provides the option of allowing the watermark to be more weakly embedded in the content, thereby reducing its visibility under inspection by potential fraudulent parties, or reducing it's perceptibility under normal viewing conditions.

One preferred metric is a mean square value of the cluster, which has been found to offer a particularly good indication of the presence of a correlation peak.

The metric can be calculated for each of a plurality of different clusters selected from the overall set of results. Indeed, the metric can be calculated for a cluster of results centred on each correlation result in the set of correlation results. However, a more efficient method uses an initial stage of identifying candidate clusters of results which are likely to represent correlation peaks. The metric only needs to be calculated for the candidate clusters, thereby significantly reducing the amount of computation.

The functionality described here can be implemented in software, hardware or a combination of these. Accordingly, another aspect of the invention provides software for performing the method. It will be appreciated that software may be installed on the host apparatus at any point during the life of the equipment. The software may be stored on an electronic memory device, hard disk, optical disk or other machine-readable storage medium. The software may be delivered as a computer program product on a machine-readable carrier or it may be downloaded directly to the apparatus via a network connection.

Further aspects of the invention provide a watermark detector for performing any of the steps of the method and an apparatus for presenting an information signal which responds to the output of the watermark detector.

While the described embodiment makes reference to processing an image or video signal (including digital cinema content), it will be appreciated that the information signal can be data representing audio or any other kind of media content.

Embodiments of the present invention will now be described, by way of example only, with reference to the accompanying drawings, in which:

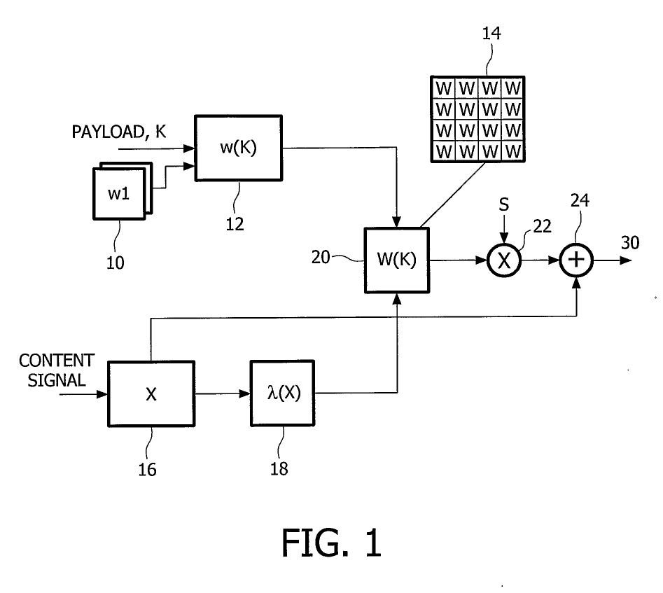

FIG. 1 shows a known way of embedding a watermark in an item of content;

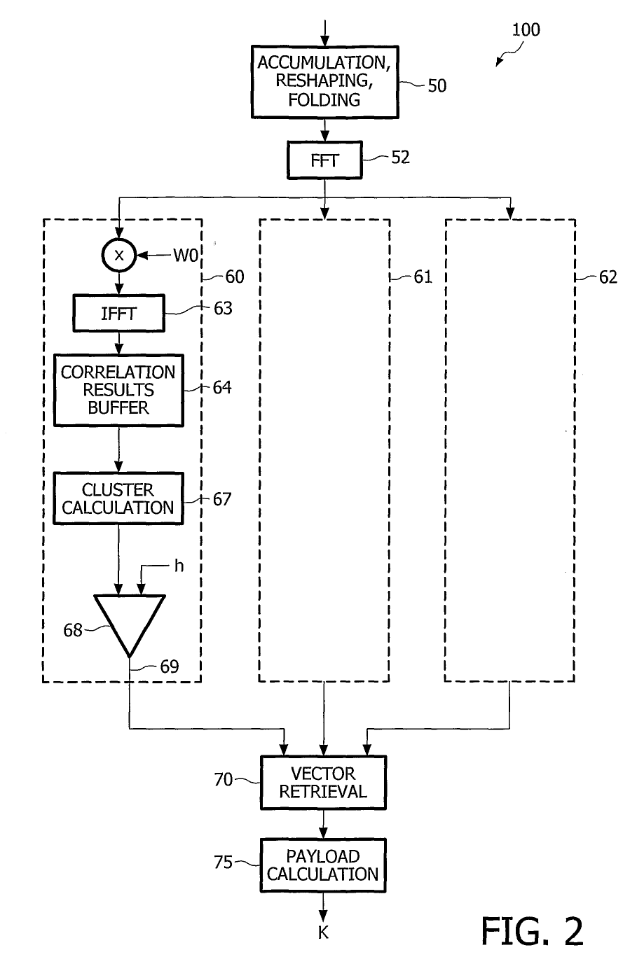

FIG. 2 shows a first arrangement for detecting the presence of a watermark in an item of content;

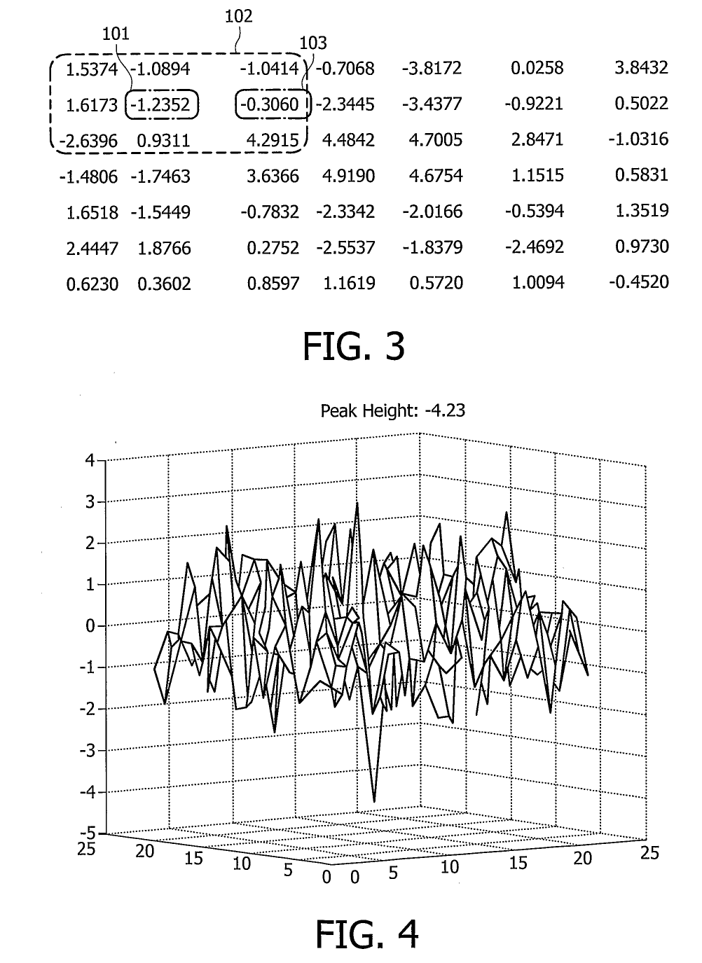

FIG. 3 shows a table of correlation results and selection of a cluster of results for use in the detection method;

FIG. 4 shows a graph of correlation result data;

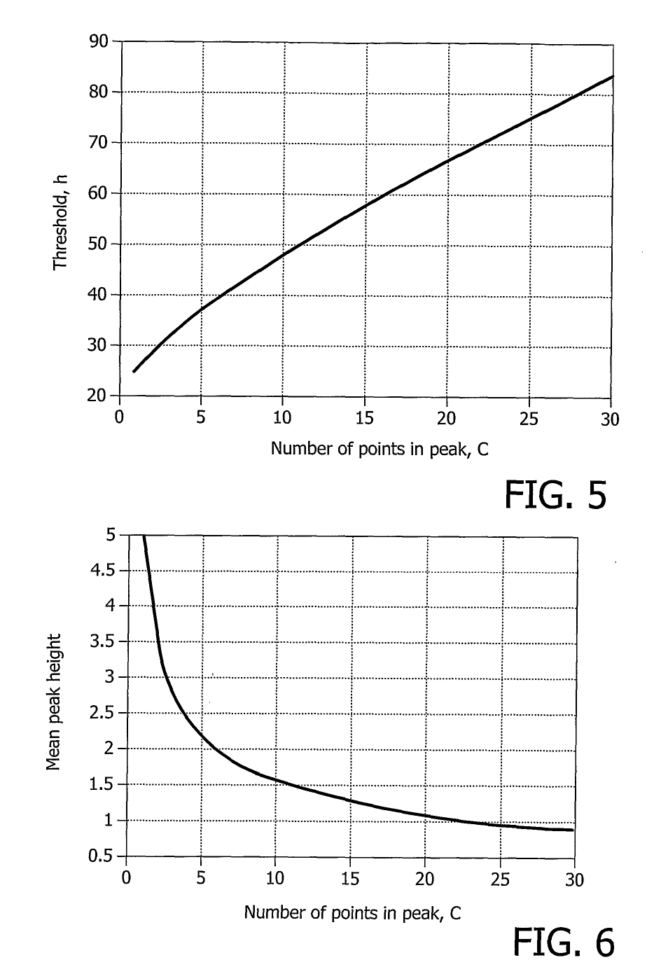

FIGS. 5 and 6 show graphs which illustrate performance of the detector and method;

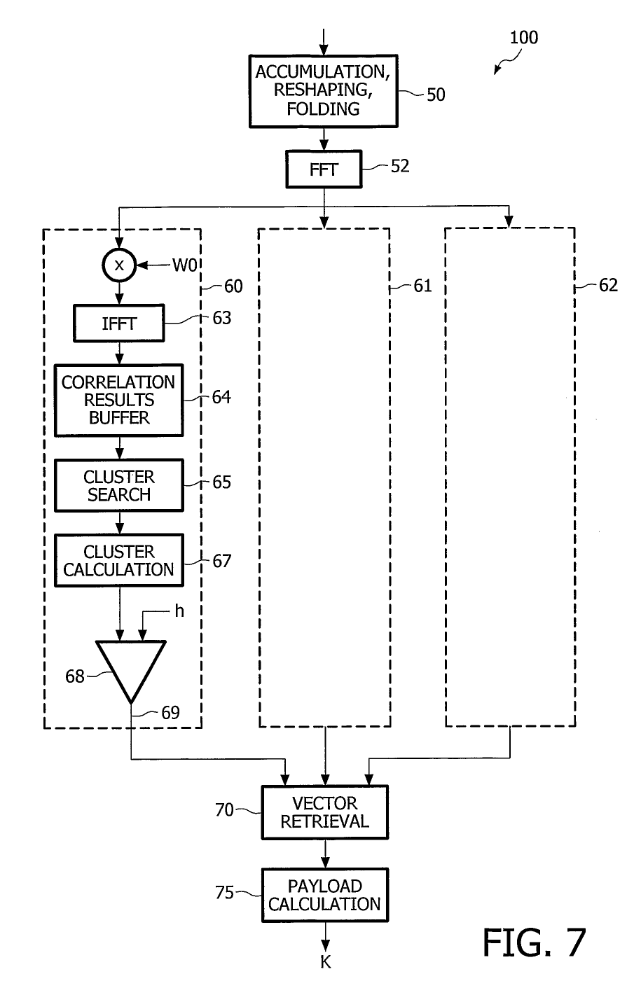

FIG. 7 shows a second arrangement for detecting the presence of a watermark in an item of content;

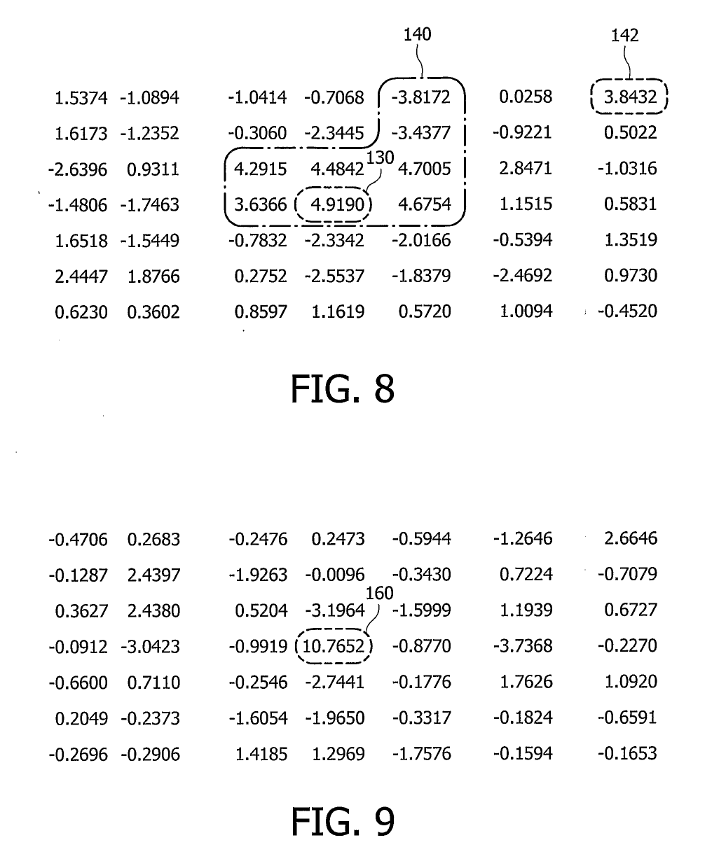

FIGS. 8 and 9 show tables of correlation results data and the process of identifying significant clusters;

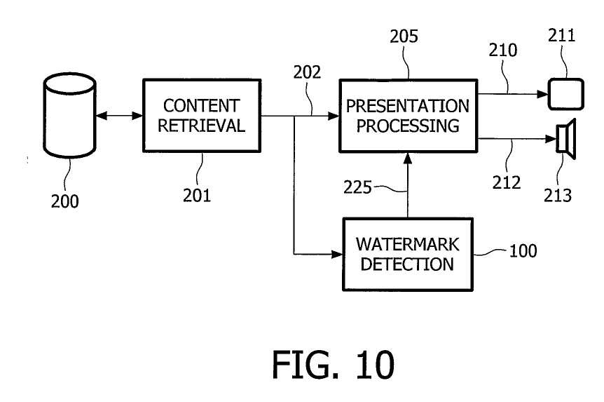

FIG. 10 shows apparatus for presenting content which embodies the watermark detector.

By way of background, and to understand the invention, a process of embedding a watermark will be briefly described, with reference to FIG. 1. A watermark pattern w(K) is constructed using one or more basic watermark patterns w. Where a payload of data is to be carried by the watermark, a number of basic watermark patterns are used. The watermark pattern w(K) is chosen according to the payload—a multi-bit code K—that is to be embedded. The code is represented by selecting a number of the basic patterns w and offsetting them from each other by a particular distance and direction. The combined watermark pattern w(K) represents a noise pattern which can be added to the content. The watermark pattern w(K) has a size of M×M bits and is typically much smaller than the item of content. Consequently, the M×M pattern is repeated (tiled) 14 into a larger pattern which matches the format of the content data. In the case of an image, the pattern w(K) is tiled 14 such that it equals the size of the image with which it will be combined.

A content signal is received and buffered 16. A measure of local activity λ(X) in the content signal is derived 18 at each pixel position. This provides a measure for the visibility of additive noise and is used to scale the watermark pattern W(K). This prevents the watermark from being perceptible in the content, such as areas of equal brightness in an image. An overall scaling factor s is applied to the watermark at multiplier 22 and this determines the overall strength of the watermark. The choice of s is a compromise between the degree of robustness that is required and the requirement for how perceptible the watermark should be. Finally, the watermark signal W(K) is added 24 to the content signal. The resulting signal, with the watermark embedded within it, will then be subject to various processing steps as part of the normal distribution of that content.

FIG. 2 shows a schematic diagram of a watermark detector 100. The watermark detector receives content that may be watermarked. In the following description the content is assumed to be images or video content. Watermark detection may be performed for individual frames or for groups of frames. Accumulated frames are partitioned into blocks of size M×M (e.g. M=128) and then folded into a buffer of size M×M. These initial steps are shown as block 50. The data in the buffer is then subject to a Fast Fourier Transform 52. The next step in the detection process determines the presence of watermarks in the data held in the buffer. To detect whether or not the buffer includes a particular watermark pattern W, the buffer contents and the expected watermark pattern are subjected to correlation. As the content data may include multiple watermark patterns, a number of parallel branches 60, 61, 62 are shown, each one performing correlation with one of the basic watermark patterns W0, W1, W2. One of the branches is shown in more detail. The correlation values for all possible shift vectors of a basic pattern Wi are simultaneously computed. The basic watermark pattern Wi (i=0, 1, 2) is subjected to a Fast Fourier Transform (FFT) before correlation with the data signal. The set of correlation values is then subject to an inverse Fast Fourier transform 63. Full details of the correlation operation are described in U.S. Pat. No. 6,505,223 B1.

The Fourier coefficients used in the correlation are complex numbers, with a real part and an imaginary part, representing a magnitude and a phase. It has been found that the reliability of the detector is significantly improved if the magnitude information is thrown away and the phase is considered only. A magnitude normalization operation can be performed after the pointwise multiplication and before the inverse Fourier Transform 63. The operation of the normalization circuit comprises pointwise dividing each coefficient by its magnitude. This overall detection technique is known as Symmetrical Phase Only Matched Filtering (SPOMF).

The set of correlation results from the above processing are stored in a buffer 64. A small example set of correlation results are shown in FIG. 3. Watermarked content is indicated by the presence of peaks in the correlation results data. The shape of the peak can be better understood by viewing the correlation results in the form of a graph, with the correlation value being plotted as height above a base line of the graph, as shown in FIG. 4. In this example, the peak is a relatively sharp peak having a value of −4.23.

The set of correlation results are examined to identify peaks that might be due to the presence of a watermark in the content data. The presence of a watermark may be indicated by a sharp, isolated peak of significant height, although most isolated peaks tend to represent spurious matches due to noise. It is more likely that previous processing operations during distribution of the content will have caused a correlation peak due to a watermark to be smeared over several adjacent positions in the correlation results.

In the next step, cluster calculation unit 67 forms clusters of results from the set of results in the buffer and calculates the mean square value of the cluster. As an example, one such cluster is formed by taking the results surrounding the result marked 101. Here, the cluster is a 3×3 square of results 102. The mean square of that cluster is calculated. Another cluster is formed by taking a 3×3 cluster of results surrounding point 103. The mean square of that cluster is calculated. The method continues until a mean square has been calculated for every possible cluster of results in the buffer. The size C of the cluster can be set in advance or it can be varied, in use. In generating the set of correlation results 64, a cyclic correlation is used. Thus, entries in the bottom row neighbour entries in the top row. Looking at FIG. 3, and taking the top row value of −3.8172 as the centre of a cluster, other results in this cluster will be taken from the top row, second row and bottom row of the buffer.

The set of mean square values are compared with a threshold value h at a comparator 68. If one of the mean square values exceeds the threshold, that cluster is taken as representing the position of the correlation peak. With the threshold value set at a suitable value, it is highly unlikely that more than one of the mean square values will exceed the threshold. However, if multiple peaks are found, they should be decided between based upon their probability of being due to a watermark. Output 69 indicates the position of the correlation peak.

A simplified mathematical example of the mean-square technique will now be described. Consider that an item of content has been correlated with a watermark pattern of interest using the SPOMF technique previously described and the correlation results stored in buffer 64. The correlation results in buffer 64 are a vector y of correlation values with each element corresponding to a different (cyclic) shift of the watermark pattern relative to the content signal. For clarity it is assumed that y is one-dimensional although it will be appreciated that for most content the correlation results in buffer 64 will be a two-dimensional matrix corresponding to shifts in the horizontal and vertical directions. In the case of unwatermarked material ( H̅_̅{̅W̅}̅) it has been shown that the elements of y are approximately independent White Gaussian Noise (WGN). In the case of watermarked material (H_{W}), experiment shows that the buffer results are again approximately gaussian noise, but there also exists a peak. Suppose that the form of the correlation peak comprises C adjacent points such that the peak shape vectors s_{τ} is:

$${s}_{τ} ( k ) = A {\sum }_{i = 0}^{C - 1} {a}_{i} δ ( k - τ - ⅈ ) \qquad ( 1 )$$

The shape of the peak is controlled by the vector of parameters:
a=[a₀ a₁ . . . a_{C-1}]^{T}
The motivation for using this particular model of the peak shape is that it is more general than assuming a particular mathematical shape (e.g. a sinc function) and uses the knowledge that the peak is a small feature within a large buffer, i.e. the extent of the peak, C, is much smaller than the length N of the buffer y.

The detection criterion is the highest cluster of points rather than the single highest point. The decision rule is:

$${\sum }_{i = 0}^{C - 1} {y}^{2} ( \hat{τ} + ⅈ ) > h ⇒ {H}_{W} else \overline{{H}_{W}}$$

where \hat{τ} is chosen to be the location in y with the highest cluster of C adjacent points:

$$\hat{τ} = arg {max}_{k} [ {\sum }_{i = 0}^{C - 1} {y}^{2} ( k + ⅈ ) ]$$

This represents:
finding the position \hat{τ} in the correlation buffer results 64 of the cluster of C points possessing the highest sum of squared heights;
comparing the sum of squared heights at location \hat{τ} to the threshold h.

The detection threshold h required to achieve a desired false positive probability of α can be found as follows. Firstly, define χ as:

$$χ ( k ) = {\sum }_{i = 0}^{C - 1} {y}^{2} ( k + ⅈ )$$

For unwatermarked content, χ has a Chi-square probability distribution order of order C. The appropriate value of h can be determined from:

$$Pr [ χ < h ] = {( 1 - α )}^{\frac{1}{N}}$$

by using tables of the Chi-Square distribution. This detection criterion and threshold setting are derived in the Appendix.

Different cluster sizes (C) result in a different order of the Chi-square distribution, which will result in different threshold settings.

FIG. 5 shows the threshold value h required for watermark detection required for PAL video using the WaterCast™ watermarking scheme developed by Philips. The threshold value h provides the same false alarm rate as a single 5σ peak. FIG. 6 shows the minimum RMS height required of these C points in order for the watermark to be declared present. It can be seen that for widely spread peak shapes, i.e. large clusters of C points, the watermark can successfully be detected at peak heights much lower than the 5σ level required by the current detectors.

In the embodiment just described, the mean-square value is calculated for every position in the results buffer 64. It is possible to significantly reduce the amount of computation by identifying, before the cluster calculation stage 67, one or more candidate clusters of results which are likely to represent smeared correlation peaks. The mean-square calculation can then be applied only to those candidate clusters. FIG. 7 shows the addition of a cluster searching stage 65 and this will now be described. The clustering algorithm forms a number of clusters of points, any of which may correspond to the true correlation peak. The algorithm comprises the following steps:

1. Set a threshold value and find all points in the correlation data which are above this threshold value. All points meeting this criteria are stored in a list—ptsAboveThresh. A suggested threshold value is 3.3σ (σ=standard deviation of results in the buffer) although this can be set to any preferred value. A preferred range is 2.5-4σ. If the threshold value is set too low a large number of points, which do not correspond to the presence of a watermark, will be stored in the list. Conversely, if the value is set too high there is a risk that points corresponding to a valid, but smeared, peak will not be added to the list.

2. Find the point with the highest absolute value.

3. Form candidate clusters, i.e. clusters of correlation points. Candidate clusters are formed by collecting points that not only have ‘significant’ value (a value greater than the threshold), but which are also located very close to at least one other point of significant value. This is achieved as follows:
(i) Remove the first point from the ptsAboveThresh list and enter it as the first point p of a new cluster;
(ii) Search ptsAboveThresh for points that are within a distance d of point p. Remove all such points from the ptsAboveThresh list, and add them to the cluster;
(iii) Take the next point in the cluster as the current point p. Repeat step (ii) in order to add to the cluster all points in ptsAboveThresh that are within distance d of the new point p.
(iv) Repeat Step (iii) until ptsAboveThresh has been processed for all points in the cluster;
(v) If the resulting cluster consists of only a single point and that point is not equal to the highest peak found in Step 2 above, then discard this cluster;
(vi) Repeat Steps (i) to (v) until ptsAboveThresh is empty.
   At the end of this procedure, all points originally entered into ptsAboveThresh in Step 1 above have been either:

assigned to a cluster containing other points from the ptsAboveThresh list that are close to it, or

discarded, as they have no neighbours of similar height, and are therefore not part of a cluster.

A cluster is only allowed to comprise a single point if that point has the largest absolute height of all the points in the correlation buffer. This prevents a sharp, unsmeared, correlation peak from being discarded, but prevents other isolated peaks, representing true noise, from being used.

Referring to FIGS. 8 and 9, these show some example sets of correlation data of the type that that would be calculated by the detector. FIG. 8 shows a set of results for a smeared peak, with values ranging between −3.8172 and 4.9190. Watermarks may be embedded with negative amplitude, giving a negative correlation peak. The highest value of 4.9190 is shown within box 130. Although this is below the typical detection threshold of 5, the highest value is surrounded by other correlation values of a similar value. This is indicative of a peak which has been smeared by processing during the distribution chain. Following the procedure described above, and setting a threshold T of 3.3 and a distance of 1, it can be found that the correlation values within ring 140 meet this criteria. Working through the process, the results of significant value are all located alongside each other. Looking at the data shown in FIG. 9, the values range between −3.7368 and 10.7652. Applying the same detection criteria, only one point 160 exceeds the threshold. The value of this point clearly exceeds the threshold and thus is considered to be a valid peak. From inspecting the neighbouring values, it can be seen that this represents a sharp correlation peak.

The embedded information represented as payload code K may identify, for example, the copy-right holder or a description of the content. In DVD copy-protection, it allows material to be labelled as ‘copy once’, ‘never copy’, ‘no restriction’, ‘copy no more’, etc. FIG. 10 shows an apparatus for retrieving and presenting a content signal which is stored on a storage medium 200, such as an optical disk, memory device or hard disk. The content signal is retrieved by a content retrieval unit 201. The content signal 202 is applied to a processing unit 205, which decodes the data and renders it for presentation 211, 213. The content signal 202 is also applied to a watermark detection unit 220 of the type previously described. The processing unit 205 is arranged so that it is only permitted to process the content signal if a predetermined watermark is detected in the signal. A control signal 225 sent from the watermark detection unit 220 informs the processing unit 205 whether processing of the content should be allowed or denied, or informs the processing unit 205 of any copying restrictions associated with the content. Alternatively, the processing unit 205 can be arranged so that it is only permitted to process the content signal if a predetermined watermark is not detected in the signal.

In the above description, a set of three watermarks have been considered. However, it will be appreciated that the technique can be applied to find a correlation peak in content data carrying only a single watermark, or to content data carrying any number of multiple watermarks.

In the description above, and with reference to the Figures, there is described a detector 100 which detects the presence of a watermark in an information signal. The information signal is correlated with an expected watermark Wi for each of a plurality of relative positions of the information signal with respect to the watermark to derive a set of correlation results 64. The mean square is calculated of a cluster of the results 64. The mean square is compared with a threshold h which is indicative of the cluster representing the presence of a correlation peak. The mean square can be calculated for clusters formed at every position in the results buffer 64. Alternatively, the mean square may be calculated only for a cluster which is identified as being a likely correlation peak.

Appendix

This section derives the example detection algorithm given earlier, and describes how to set the detection threshold to achieve a desired false positive probability.

Suppose that for watermarked content (H_{W}) the correlation results are a peak due to the watermark, plus WGN. This is supported by the observation that, with the exception of the peak itself, in the case of watermarked content the correlation results are again approximately gaussian distributed. The following hypothesis test can then be written for detecting the presence of a watermark:
H̅_̅{̅W̅}̅: y=n
H_{W}: y=n+s_{τ}
where n is a length N vector of independent WGN values and s_{τ} is a length N vector corresponding to the watermark correlation peak shape, cyclically shifted by τ positions within the correlation buffer. In the work that follows it is assumed that the noise has a standard deviation of unity. This is achieved by normalising the correlation results prior to watermark detection. Assuming momentarily that both the peak shape s and payload shift τ are known, the PDFs under each hypothesis are as follows. Under H̅_̅{̅W̅}̅ the values in y are pure WGN with PDF:

$$\begin{matrix}p ( y \text{\vert} \overline{{H}_{W}} ) = {\prod }_{k = 0}^{N - 1} {( 2 π )}^{- \frac{1}{2}} exp [ - \frac{1}{2} {y}^{2} ( k ) ] \\ = {( 2 π )}^{- \frac{N}{2}} exp [ - \frac{1}{2} {\sum }_{k = 0}^{N - 1} {y}^{2} ( k ) ]\end{matrix}$$

Under H_{W} the buffer contains a peak plus WGN and has PDF:

$$\begin{matrix}p ( y \text{\vert} {H}_{W} , s , τ ) = {\prod }_{k = 0}^{N - 1} {( 2 π )}^{- \frac{1}{2}} exp [ - \frac{1}{2} {( y ( k ) - {s}_{τ} ( k ) )}^{2} ] \\ = {( 2 π )}^{- \frac{N}{2}} exp [ - \frac{1}{2} {\sum }_{k = 0}^{N - 1} {( y ( k ) - {s}_{τ} ( k ) )}^{2} ]\end{matrix} \qquad ( 3 )$$

A decision between the two hypotheses will be made using a likelihood ratio test:

$$Likelihood ( y \text{\vert} s , τ ) = \frac{p ( y \text{\vert} {H}_{W} , s , τ )}{p ( y \text{\vert} \overline{{H}_{W}} )} > λ ⇒ {H}_{W} else \overline{{H}_{W}} \qquad ( 4 )$$

where the log-likelihood ratio is:

$$\begin{matrix}L ( y \text{\vert} s , τ ) = exp [ - \frac{1}{2} {\sum }_{k = 0}^{N - 1} {( y ( k ) - {s}_{τ} ( k ) )}^{2} + \frac{1}{2} {\sum }_{k = 0}^{N - 1} {y}^{2} ( k ) ] \\ = exp [ {\sum }_{k = 0}^{N - 1} y ( k ) {s}_{τ} ( k ) - \frac{1}{2} {\sum }_{k = 0}^{N - 1} {s}_{τ}^{2} ( k ) ]\end{matrix} \qquad ( 5 )$$

The following model of the watermark correlation peak s_{τ} is assumed:

$${s}_{τ} ( k ) = A {\sum }_{i = 0}^{C - 1} {a}_{i} δ ( k - τ - ⅈ ) \qquad ( 6 )$$

The shape of the peak is controlled by the vector of parameters:
a=[a₀ a₁ . . . a_{C-1}]^{T}

In practice, an estimated value would need to be used based upon the typical extent of spread of watermark correlation points, or a value of C can be obtained using the cluster detection technique described earlier.

Substituting Equation 6 into the log-likelihood expression of Equation 5 gives:

$$\begin{matrix}L ( y \text{\vert} a , τ ) = exp [ \begin{matrix}\begin{matrix}{\sum }_{k = 0}^{N - 1} y ( k ) ( {\sum }_{i = 0}^{C - 1} {a}_{i} δ ( k - τ - ⅈ ) ) - \\ \frac{1}{2} {\sum }_{k = 0}^{ N - 1} ( {\sum }_{j = 0}^{ C - 1} {a}_{i} δ ( k - τ - j ) )\end{matrix} \\ ( {\sum }_{l = 0}^{C - 1} {a}_{l} δ ( k - τ - l ) )\end{matrix} ] \\ = exp [ {\sum }_{i = 0}^{C - 1} {a}_{i} y ( τ + ⅈ ) - \frac{1}{2} {\sum }_{j = 0}^{C - 1} {a}_{j}^{2} ]\end{matrix} \qquad ( 7 )$$

The unknown parameters (a,τ) will be assumed to take values that maximize the likelihood of the observed data (y). Firstly, maximising with respect to the peak shape parameters gives:

$$\begin{matrix}\frac{\partial L ( y \text{\vert} a , τ )}{\partial {a}_{m}} = 0 ⇒ y ( τ + j ) - \frac{1}{2} 2 {\hat{a}}_{m} \\ = 0 \\ {\hat{a}}_{m} = y ( τ + m )\end{matrix}$$

i.e. the peak shape estimate is taken as the correlation buffer contents around the point corresponding to the payload shift, and the likelihood ratio becomes:

$${\hat{L}}_{ML} ( y \text{\vert} a , τ ) = \frac{{( {\sum }_{i = 0}^{C - 1} {a}_{i} y ( τ + ⅈ ) )}^{2}}{2 {\sum }_{j = 0}^{C - 1} {a}_{j}^{2}}$$

Choosing the estimate \hat{τ} of the payload shift to maximize the likelihood gives:

$$\begin{matrix}{\hat{L}}_{ML} ( y \text{\vert} τ ) = exp [ {\sum }_{i = 0}^{C - 1} {y}^{2} ( τ + ⅈ ) - \frac{1}{2} {\sum }_{j = 0}^{C - 1} {y}^{2} ( τ + j ) ] \\ = exp [ \frac{1}{2} {\sum }_{i = 0}^{C - 1} {y}^{2} ( τ + ⅈ ) ]\end{matrix} \qquad ( 8 )$$

Choosing the payload shift estimate \hat{τ} to maximize this expression corresponds to finding the location in y with the highest cluster of C adjacent points:

$$\hat{τ} = arg {max}_{k} [ {\sum }_{i = 0}^{C - 1} {y}^{2} ( k + ⅈ ) ]$$

$$and \text{:}$$

$${\hat{L}}_{ML} ( y ) = exp [ \frac{1}{2} {\sum }_{i = 0}^{C - 1} {y}^{2} ( \hat{τ} + ⅈ ) ]$$

This looks for the highest cluster of points rather than the single highest point. The decision rule of Eqn. 4 becomes:

$${\sum }_{i = 0}^{C - 1} {y}^{2} ( \hat{τ} + ⅈ ) > h ⇒ {H}_{W} else {H}_{W} \qquad ( 9 )$$

The necessary threshold value h to achieve an acceptably low false positive probability of value α is given by:

$$Pr [ False positive ] = Pr [ {\sum }_{i = 0}^{C - 1} {y}^{2} ( \hat{τ} + ⅈ ) > h \vert \overline{{H}_{W}} ] = α \qquad ( 10 )$$

Under hypothesis H̅_̅{̅W̅}̅ the elements of y are independently gaussian distributed with zero mean and unit standard deviation. The variable χ, defined as:

$$χ ( k ) = {\sum }_{i = 0}^{C - 1} {y}^{2} ( k + ⅈ )$$

therefore has a Chi-Square distribution of order C. using this notation, Eqn. 10 becomes:

$$\begin{matrix}1 - Pr [ χ ( k ) < h , ∀ k ] = α \\ ⇒ 1 - {( Pr [ χ < h ] )}^{N} = α \\ ⇒ Pr [ χ < h ] = {( 1 - α )}^{\frac{1}{N}}\end{matrix}$$

from which the appropriate value of h can be determined via tables of the Chi-Square distribution.

1. A method of detecting a watermark in an information signal, comprising:
deriving a set of correlation results (64) by correlating the information signal with a watermark (Wi) for each of a plurality of relative positions of the information signal with respect to the watermark;
calculating a metric which is based on a cluster (102) of the results (64) selected from the overall set of results; and
comparing the calculated metric with a cluster threshold value (h) which is indicative of the cluster (102) representing a correlation peak.

2. A method according to claim 1 wherein the metric is calculated for a plurality of different clusters selected from the overall set of results (64).

3. A method according to claim 2 wherein the metric is calculated for a cluster of results centred on each correlation result in the set of correlation results (64).

4. A method according to claim 1 wherein the metric is the mean square value of the cluster (102) of correlation results.

5. A method according to claim 1 wherein the cluster threshold value varies according to the size of the cluster (102).

6. A method according to claim 1 further comprising an initial step of identifying at least one cluster of correlation results which are likely to represent a correlation peak and only performing the step of calculating the metric on each of the identified clusters.

7. A method according to claim 6 wherein the step of identifying clusters of correlation results comprises determining all correlation results in the set which exceed a detection threshold value and then determining which of those correlation results are located within a predetermined distance of each other.

8. (canceled)

9. A watermark detector for detecting a watermark in an information signal, comprising:
means for deriving a set of correlation results (64) by correlating the information signal with a watermark (Wi) for each of a plurality of relative positions of the information signal with respect to the watermark;
means for calculating a metric based on a cluster (102) of the results selected from the overall set of results (64); and
means for comparing the calculated metric with a cluster threshold value (h) which is indicative of the cluster representing a correlation peak.

10. (canceled)

11. A watermark detector according to claim 9 wherein the means for deriving a set of correlation results, the means for calculating a metric and the means for comparing the calculated metric comprise a processor which is arranged to execute software for performing those functions.

12. Apparatus for presenting an information signal comprising means for disabling operation of the apparatus in dependence on the presence of a valid watermark in the information signal, wherein the apparatus comprises a watermark detector according to claim 9.

13. A watermark detector for detecting a watermark in an information signal, comprising:
a processor for deriving a set of correlation results by correlating the information signal with a watermark for each of a plurality of relative positions of the information signal with respect to the watermark; said processor calculating a metric based on a cluster of the results selected from the overall set of results; said processor further comparing the calculated metric with a cluster threshold value which is indicative of the cluster representing a correlation peak.
